(19) United States
(12) Patent Application Publication
(10) Pub. No.: US 2013/0002661 A1
(43) Pub. Date: Jan. 3, 2013

(54) STEREOSCOPIC IMAGE DISPLAY APPARATUS AND METHOD OF CONTROLLING SAME

(76) Inventors: Kouichi Tanaka, Saitama-shi (JP); Tetsu Wada, Saitama-shi (JP); Hisashi Endo, Saitama-shi (JP)

(21) Appl. No.: 13/583,910

(22) PCT Filed: Oct. 13, 2010
(86) PCT No.: PCT/JP2010/068419

§ 371 Date: Sep. 10, 2012

(30) Foreign Application Priority Data
Mar. 18, 2010 (JP) 2010-063274

(51) Int. Cl. G06T 15/00; G06F 3/041

(52) U.S. Cl. 345/419; 345/173

(57) ABSTRACT

Designated positions in a left-eye image and in a right-eye image are detected. The dominant eye is input and, if there is a position designation made by the observer, the coordinate position of the designated position is calculated in each of the left-eye and right-eye images. A template image is detected from the dominant-eye image and an image identical with the detected template image is detected from the non-dominant-eye image. Positions in respective ones of the template image and matching image become the designated positions. A distance differential between the template image detected from the dominant-eye image and the image detected from the non-dominant-eye image is parallax. The parallax of the designated positions is adjusted.

### TECHNICAL FIELD

This invention relates to a stereoscopic image display apparatus and to a method of controlling this apparatus.

### BACKGROUND ART

A stereoscopic image is composed of a left-eye image observed by the left eye of the user and a right-eye image observed by the right eye of the user. The left-eye and right-eye images have a left-right offset and appear stereoscopically owing to this offset. In a case where the parallax of a certain image portion contained in the stereoscopic image is to be adjusted, this image portion is designated. The parallax of the designated image portion is adjusted (Japanese Patent Application Laid-Open No. 10-105735). Further, in a case where a stereoscopic image is designated using a cursor, the dominant eye is taken into consideration (Japanese Patent Application Laid-Open No. 2004-362218).

However, no thought has been given to accurate detection of positions in respective ones of the left-eye and right-eye images, which constitute the stereoscopic image, in a case where the user has designated an image portion contained in the stereoscopic image.

### DISCLOSURE OF THE INVENTION

An object of the present invention is to detect positions in respective ones of left-eye and right-eye images in a case where an image portion contained in a stereoscopic image has been designated.

A first aspect of the present invention is characterized in that a stereoscopic image display apparatus for allowing a user to view a stereoscopic image by displaying on a display screen a left-eye image observed by the left eye of the user and a right-eye image observed by the right eye of the user comprises: a dominant-eye setting device (dominant-eye setting means) for setting a dominant eye of the user; a position designating device (position designating means) for designating a position on the display screen at which a portion whose parallax is to be adjusted is being displayed; a template image detecting device (template image detecting means) for detecting, as a template image in whichever of the left-eye image or right-eye image is an image observed by the dominant eye set by the dominant-eye setting device, an image portion that exists at a position corresponding to the position on the display screen designated by the image designating device; and a template matching device (template matching means) for detecting the position of a matching image, which is an image identical with the template image detected by the template image detecting device, in whichever of the left-eye image or right-eye image is an image observed by an eye different from the dominant eye set by the dominant-eye setting device. (The matching image may be an image that appears substantially the same as the template image, such as the closest resembling image, and need not be a perfectly identical image. Further, it may be an image such as one considered to correspond to the template image.)

The first aspect of the present invention also provides a method of controlling the above-described stereoscopic image display apparatus. Specifically, the method, which is a method of controlling a stereoscopic image display apparatus for allowing a user to view a stereoscopic image by displaying on a display screen a left-eye image observed by the left eye of the user and a right-eye image observed by the right eye of the user, comprises: setting a dominant eye of the user; designating a position on the display screen at which a portion whose parallax is to be adjusted is being displayed; detecting, as a template image in whichever of the left-eye image or right-eye image is an image observed by the set dominant eye, an image portion that exists at a position corresponding to the designated position on the display screen; and detecting the position of a matching image, which is an image identical with the detected template image, in whichever of the left-eye image or right-eye image is an image observed by an eye different from the set dominant eye.

In accordance with the first aspect of the present invention, the dominant eye of the user is set and a position on a display screen at which a portion whose parallax is to be adjusted is being displayed is designated. In a case where an image portion constituting a stereoscopic image is designated, it is considered that what is often designated is the image portion of the image, which is either the left-eye image or the right-eye image, seen by the dominant eye. For this reason, a corresponding image portion in the image observed by the dominant eye is detected as a template image from the position designated by the user, and the position of a matching image, which is an image identical with the template image, is detected from the image observed by the eye different from the dominant eye. The detected position of the template image and the detected position of the matching image become a designated position on the dominant-eye image and a designated position on the non-dominant-eye image. When the template image and the matching image are detected, parallax represented by the distance between the template image and the matching image, for example, is adjusted. The positions in respective ones of the left-eye and right-eye images corresponding to the position designated by the user are detected and the parallax of these positions can be adjusted comparatively accurately.

By way of example, the template image detecting device includes: an edge component amount determination device (edge component amount determination means) for determining, in whichever of the left-eye image or right-eye image is an image observed by the dominant eye set by the dominant-eye setting device, whether an amount of edge components of an image within a template-image candidate area of a prescribed size centered on the position corresponding to the position on the display screen designated by the position designating device is equal to or greater than a prescribed threshold value; an enlarging device (enlarging means) for enlarging the size of the template-image candidate area in accordance with a determination by the edge component amount determination device that the amount of edge component amounts is not equal to or greater than the prescribed threshold value; a control device (control means) for controlling the edge component amount determination device so as to determine whether the amount of edge components of the image within the template image candidate area enlarged by the enlarging device is equal to or greater than the prescribed threshold value; and a template image deciding device (template image deciding means) for deciding, in accordance with a determination by the edge component amount determination device that the amount of edge components is equal to or greater than the prescribed threshold value, that the image within the template-image candidate area is a template image.

The apparatus may further comprise an intersection position detecting device (intersection position detecting means) for detecting whether an intersection between a left-eye line of sight and a right-eye line of sight of the user is forward or rearward of the display screen. In this case, the template matching device, in accordance with a determination by the intersection position detecting device that the intersection is forward of the display screen, detects the matching image from the image observed by the different eye in a direction on the dominant-eye side of the position corresponding to the position on the display screen designated by the position designating device, and in accordance with a determination by the intersection position detecting device that the intersection is rearward of the display screen, detects the position of the matching image from the image observed by the different eye in a direction on the non-dominant-eye side of the position corresponding to the position on the display screen designated by the position designating device.

In a case where a touch panel has been formed on the display screen, the position designating device includes a pressure determination device (pressure determination means) for determining whether pressure at a position touched on the touch panel is equal to or greater than a prescribed reference value, by way of example. Further, the template matching device, in accordance with a determination by the pressure determination device that the pressure is equal to or greater than the prescribed reference value, detects the matching image from the image observed by the different eye in a direction on the dominant-eye side of the position corresponding to the position on the display screen designated by the position designating device, and in accordance with a determination by the pressure determination device that the pressure is less than the prescribed reference value, detects the position of the matching image from the image observed by the different eye in a direction on the non-dominant-eye side of the position corresponding to the position on the display screen designated by the position designating device.

By way of example, the template image detecting device detects a feature point, which is in the vicinity of the image portion that exists at the position corresponding to the position on the display screen designated by the position designating device, in whichever of the left-eye image or right-eye image is an image observed by the dominant eye set by the dominant-eye setting device. By way of example, the template matching device detects a feature point, which corresponds to the feature point detected by the template image detecting device, in whichever of the left-eye image or right-eye image is an image observed by the eye different from the dominant eye set by the dominant-eye setting device.

A second aspect of the present invention is characterized in that a stereoscopic image display apparatus for allowing a user to view a stereoscopic image by displaying on a display screen a left-eye image observed by the left eye of the user and a right-eye image observed by the right eye of the user comprises: a dominant-eye setting device (dominant-eye setting means) for setting a dominant eye of the user; a position designating device (position designating means) for designating a position on the display screen at which a portion whose parallax is to be adjusted is being displayed; a designated-position coordinate detecting device (designated-position coordinate detecting device) for detecting designated-position coordinates, which correspond to the position on the display screen designated by the image designating device, in whichever of the left-eye image or right-eye image is an image observed by the dominant eye set by the dominant-eye setting device; a corresponding-position-coordinate existence/non-existence determination device (corresponding-position-coordinate existence/non-existence determination means) for determining whether items of data, which represent both a position within a prescribed range from the designated-position coordinates detected by the designated-position-coordinate detecting device and a position corresponding to the position within the prescribed range in whichever of the left-eye image or right-eye image is an image observed by an eye different from the dominant eye set by the dominant-eye setting device, have been stored in a memory; a readout device (readout means) for reading the items of data representing both of the positions out of the memory in response to a determination by the corresponding-position-coordinate existence/non-existence determination device that the data representing both of the positions has been stored in the memory; a template image detecting device (template image detecting means), responsive to a determination by the corresponding-position coordinate existence/non-existence determination device that at least one item of the items of data representing both of the positions has not been stored in the memory, for detecting, as a template in whichever of the left-eye image or right-eye image is an image observed by the dominant eye set by the dominant-eye setting device, an image portion that exists at a position corresponding to the position on the display screen designated by the image designating device; a template matching device (template matching means) for detecting the position of a matching image, which is an image identical with the template image detected by the template image detecting device, in whichever of the left-eye image or right-eye image is an image observed by the eye different from the dominant eye set by the dominant-eye setting device; and a memory control device (memory control means) for storing, in the memory, data representing the position of the template image detected by the template image detecting device and contained in the image observed by the dominant eye and data representing the position of the matching image detected by the template matching device and contained in the image observed by the eye different from the dominant eye.

The second aspect of the present invention also provides a method of controlling the above-described stereoscopic image display apparatus. Specifically, this method, which is a method of controlling a stereoscopic image display apparatus for allowing a user to view a stereoscopic image by displaying on a display screen a left-eye image observed by the left eye of the user and a right-eye image observed by the right eye of the user, comprises: setting a dominant eye of the user; designating a position on the display screen at which a portion whose parallax is to be adjusted is being displayed; detecting designated-position coordinates, which correspond to the designated position on the display screen, in whichever of the left-eye image or right-eye image is an image observed by the set dominant eye; determining whether items of data, which represent both a position within a prescribed range from the detected designated-position coordinates and a position corresponding to the position within the prescribed range in whichever of the left-eye image or right-eye image is an image observed by an eye different from the set dominant eye, has been stored in a memory; reading the items of data representing both of the positions out of the memory in response to a determination that the items of data representing both of the positions have been stored in the memory; in response to a determination that at least one item of the items of data representing both of the positions has not been stored in the memory, detecting, as a template in whichever of the left-eye image or right-eye image is an image observed by the set dominant eye, an image portion that exists at a position corresponding to the designated position on the display screen; detecting the position of a matching image, which is an image identical with the detected template image, in whichever of the left-eye image or right-eye image is an image observed by the eye different from the set dominant eye; and storing, in the memory, data representing the position of the template image detected and contained in the image observed by the dominant eye and data representing the position of the matching image detected and contained in the image observed by the eye different from the dominant eye.

In accordance with the second aspect of the present invention, when an image portion constituting a stereoscopic image is designated in the manner described above, a check is performed to determine whether a position in the vicinity of a position designated in a dominant-eye image (the left-eye image or the right-eye image) and the position of a non-dominant-eye image corresponding to this position have been stored in a memory. If the position in the vicinity of the designated position and the position corresponding to this position in the vicinity have been stored in the memory, then a position in the left-eye image and a position in the right-eye image that have been stored in the memory are read out. If both the position in the vicinity of the designated position and the position corresponding to this position in the vicinity have not been stored in the memory, then detection of the template image and of the matching image is carried out in the manner described above and a parallax adjustment is performed based upon the offset between the detected template image and matching image. In a case where positions that have been stored in the memory can be utilized, a parallax adjustment can be carried out comparatively quickly.

### BRIEF DESCRIPTION OF THE DRAWINGS

FIG. 1 is a block diagram illustrating the electrical configuration of a stereoscopic image display apparatus;

FIG. 2 is a flowchart illustrating the processing procedure of the stereoscopic image display apparatus;

FIG. 3 is an external view of the stereoscopic image display apparatus;

FIG. 4 is an example of a right-eye image;

FIG. 5 is an example of a left-eye image;

FIG. 6 is a block diagram illustrating the electrical configuration of a template setting unit;

FIG. 7 is a flowchart illustrating a template image detection processing procedure;

FIG. 8 is a block diagram illustrating the electrical configuration of a stereoscopic image display apparatus;

FIG. 9 illustrates the relationship among an image portion designated by a user, a display screen, a right-eye image and a left-eye image;

FIG. 10 illustrates the relationship among an image portion designated by a user, a display screen, a right-eye image and a left-eye image;

FIG. 11 is a flowchart illustrating the processing procedure of the stereoscopic image display apparatus;

FIG. 12 is a block diagram illustrating the electrical configuration of a stereoscopic image display apparatus;

FIG. 13 is a flowchart illustrating the processing procedure of the stereoscopic image display apparatus;

FIG. 14 is a flowchart illustrating the processing procedure of the stereoscopic image display apparatus;

FIG. 15 is a block diagram illustrating the electrical configuration of a stereoscopic image display apparatus;

FIG. 16 is an example of a right-eye image;

FIG. 17 is an example of a left-eye image;

FIG. 18 is a flowchart illustrating the processing procedure of the stereoscopic image display apparatus;

FIG. 19 is a block diagram illustrating the electrical configuration of a stereoscopic image display apparatus;

FIG. 20 is an example of a history information table;

FIG. 21 is a flowchart illustrating the processing procedure of the stereoscopic image display apparatus; and

FIG. 22 is a flowchart illustrating the processing procedure of the stereoscopic image display apparatus.

### BEST MODE FOR CARRYING OUT THE INVENTION

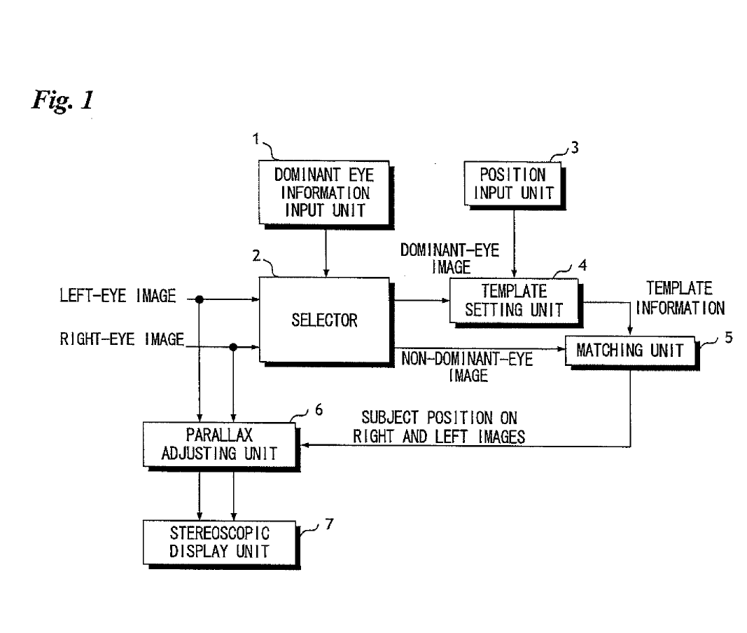

FIG. 1, which shows an embodiment of the present invention, is a block diagram illustrating the electrical configuration of a stereoscopic image display apparatus.

The stereoscopic image display apparatus allows an observer to view a stereoscopic image by displaying on a display screen of a stereoscopic display unit 7 a right-eye image observed by the right eye of the observer and a left-eye image observed by the left eye of the observer. In this embodiment, the position of the right-eye image corresponding to a position designated by the observer and a position in the left-eye image are measured accurately in the image of a subject being displayed on the display screen of the stereoscopic display unit 7.

First, the dominant eye of the observer (user, operator) is input from a dominant eye information input unit 1. The dominant eye information input unit 1 may be dominant eye information input button that outputs a command indicating that the dominant eye is the left eye or the right eye, or an arrangement may be adopted in which a menu for inputting dominant eye information is displayed on the display screen of the stereoscopic display unit 7 and the dominant eye is set from the menu. Data representing the dominant eye of the observer that has been output from the dominant eye information input unit 1 is input to a selector 2.

Both left-eye image data representing the left-eye image and right-eye image data representing the right-eye image is input to the selector 2 and to a parallax adjusting unit 6. Based upon the dominant eye information that has been input from the dominant eye information input unit 1, the selector 2 is changed over so as to input to the template setting unit 4 whichever of the left-eye image data or right-eye image data is image data observed by the dominant eye (namely dominant-eye image data) and input to a matching unit 5 the image data observed by the eye that is different from the dominant eye (namely non-dominant-eye image data.

The left-eye image data and the right-eye image data is applied to the stereoscopic display unit 7 via the parallax adjusting unit 6. The left-eye image and the right-eye image are displayed on the display screen of the stereoscopic display unit 7, whereby the observer can see a stereoscopic image.

A portion desired to be have its parallax adjusted (there need not necessarily be a parallax adjustment) is designated in the stereoscopic image by the observer using a position input unit 3. If a touch panel has been formed on the display screen of the stereoscopic display unit 7, the position is designated by touching the touch panel. In a case where a touch panel has not been formed, a cursor moved in accordance with mouse operation is displayed on the display screen and position can be designated by a clicking operation using the mouse, by way of example.

Data representing the designated position that is output from the position input unit 3 is input to the template setting unit 4. An image portion in the vicinity of the position designated by the observer is set as a template image in the dominant-eye image. Data representing the set template image and data representing the position of the template image (e.g., the center position or barycentric position, etc., of the template image) in the dominant-eye image is input from the template setting unit 4 to the matching unit 5. The data representing the position of the template image in the dominant-eye image enters the parallax adjusting unit 6 simply by passing through the matching unit 5.

The position of an image portion (a matching image) identical with the template image is detected by the matching unit 5 in the non-dominant-eye image from the entered non-dominant eye data and template image data. When this is done, data representing the position of the image portion, which is identical with the template image, on the non-dominant-eye image is applied to the parallax adjusting unit 6 from the matching unit 5.

Matching processing for detecting the image identical with the template image can be executed as follows: The most fundamental criterion for judging the interrelationship between a point p(x,y) on the right-eye image and a point q(u,v) on the left-eye image is a sum of the absolute values of residuals within windows the respective centers of which are the points p and q. The sum of the absolute values of the residuals is expressed by Equation (1) below.

$$R ( x , y , u , v ) = {\sum }_{( i , j ) ∈ Template} \vert P ( x + i , y + j ) - Q ( u + i , v + j ) \vert \qquad Equation ( 1 )$$

In Equation (1), i and j represent pixel positions within the windows when (x,y) and (u,v) are adopted as the respective origins. Further, P(x,y) and Q(u,v) represent the luminance value of pixel (x,y) on the right-eye image and the luminance value of pixel (x,y) on the left-eye image, respectively. It can be said that the smaller the value R(u,v) in Equation (1), the higher the correlation value of p(x,y) and q(u,v). If we assume that the dominant eye is the right eye and that a template image whose center is the point p(x,y) has been extracted from the right-eye image, then the value of Equation (1) is calculated at each pixel q(u,v) on the same horizontal line as that of p(x,y) on the left-eye image, and the point for which the value is smallest among these pixels is adopted as a point that coincides with the point p(x,y). Thus, an image portion of the left-eye image corresponding to the template image on the right-eye image is detected accurately.

Since data representing the position of the template image in the dominant-eye image and data representing the position of the image (matching image) identical with the template image in the non-dominant-eye image is input to the parallax adjusting unit 6, the parallax between the left-eye image and right-eye image can be adjusted comparatively accurately. Image data representing the left-eye image and image data representing the right-eye image, which have had their parallax adjusted, is applied to the stereoscopic display unit 7, whereupon the parallax-adjusted left-eye image and right-eye image are displayed on the stereoscopic display unit 7 so that the observer can observe a stereoscopic image. For example, by making the parallax of the designated image portion zero or by emphasizing the degree of image pop-up, the designated image portion can be made easier to view stereoscopically and the three-dimensional effect can be strengthened.

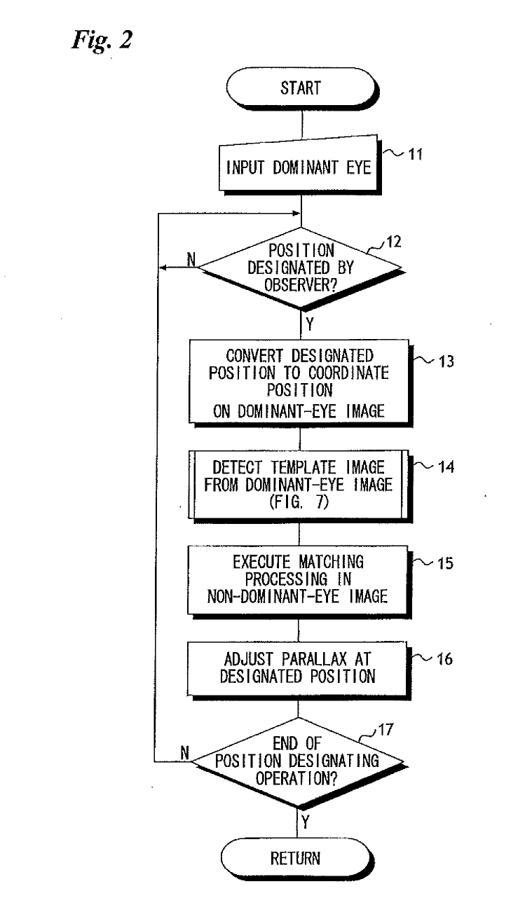

FIG. 2 is a flowchart illustrating the processing procedure of the stereoscopic display system.

As mentioned above, the dominant eye of the observer is input (step 11). Next, whether the observer has made a position designation with respect to the stereoscopic image is determined (step 12).

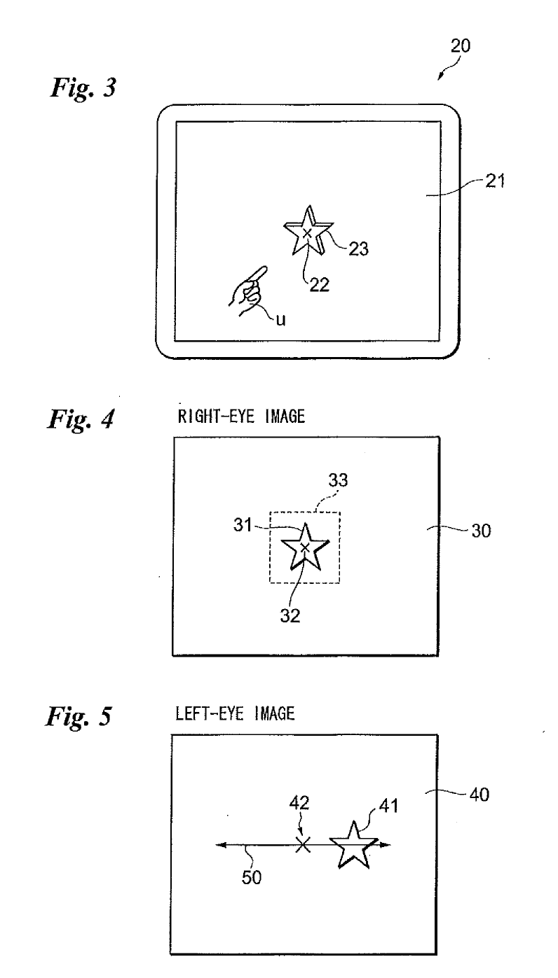

FIG. 3 illustrates an overview of the stereoscopic display system.

When the left-eye image data and right-eye image data is applied to the stereoscopic display system, the left-eye image and right-eye image are displayed on the a display screen 21 of the stereoscopic display unit, whereby a stereoscopic image can be observed, as described above. An image portion 22 the parallax of which is desired to be corrected is touched in this stereoscopic image by a finger u of the observer. Owing to such touching of the image portion, a position designation is construed as having taken place and the touched position becomes a designated position 23. It goes without saying that a touch panel (not shown) can be formed on the display screen 21 and the touched position can be detected. A position designation utilizing a mouse is of course permissible without a touch panel being provided.

With reference again to FIG. 2, the designated position is converted to a coordinate position on the dominant-eye image (on the left-eye image or right-eye image) (step 13).

FIG. 4 is an example of the right-eye image.

Assume that the set dominant eye is the right eye. In a case where the dominant eye is the right eye, it is considered that the observer (user, operator) designates a position by looking at the dominant-eye image. It is therefore considered that, in a right-eye image 30, the observer has designated a position 32 contained in an image portion 31 included in the right-eye image 30. The positional coordinates of the designated position 23 on the display screen 21 correspond to the coordinates of the position 32 in a case where the right-eye image 30 is displayed on the display screen 21 as is.

FIG. 5 is an example of the left-eye image.

In a case where the dominant eye is the right eye, the position 23 designated in the stereoscopic image is different from the position that results in a case where a left-eye image 40 is displayed on the display screen 21. For example, a position 42 corresponding to the position 23 designated in the stereoscopic image is on the left side of an image portion 41 that constitutes the designated image portion 22 of the stereoscopic image.

Thus, if the image is the dominant-eye image, the designated position and the position on the image will coincide, but in the case of the non-dominant-eye image, an offset will exist between the designated position and the position on the image.

With reference again to FIG. 2, a template image is detected from the dominant-eye image (step 14).

With reference to FIG. 4, it assumed that a rectangular area 33 (the area need not necessarily be rectangular) within a prescribed range from the position 31 corresponding to the position 23 designated in the stereoscopic image 21 is a template image area 33, as described above. A template image 31 is detected from within the template image area 33 by using edge detection processing or the like. Naturally, the image per se within the template image area 33 may be used as the template image.

With reference again to FIG. 2, when the template image 31 is detected from the dominant-eye image, matching processing is executed for detecting the image identical with the template image 31 from the non-dominant-eye image 40 (step 15).

With reference to FIG. 5, in this embodiment, matching processing is executed for determining whether an image identical with the template image 31 is contained in horizontal search zone 50 the center of which is the position 42 in non-dominant-eye image 40 corresponding to the designated position 23 in the stereoscopic image 21, as mentioned above. The reason for this is that it is considered that in a case where the stereoscopic image is formed using the right-eye image 30 and the non-dominant-eye image 40, an offset develops between the right-eye image 30 and the non-dominant-eye image 40 only in the left-right direction and not in the up-down direction. As a result of this matching processing, the image portion (matching image) 41 identical with the template image 31 is detected from the non-dominant-eye image 40. The result is that the designated position in the right-eye image 30 and the designated position in the non-dominant-eye image 40 are detected.

The amount of positional offset between the template image 31 detected from the right-eye image 30 and the image 41 identical with the template image 31 detected from the non-dominant-eye image 40 represents parallax. The amount of positional offset may be found by measuring the center of the image 31 and the center of the image 41, as mentioned above, or by measuring the barycenter of the image 31 and the barycenter of the image 41.

With reference again to FIG. 2, adjustment of the calculated parallax is performed by calculating the parallax (step 16). By performing a parallax adjustment of the portion of the designated position 23, the image portion 22 at the position 23 designated by the observer in the stereoscopic image can be made to be seen deeper or shallower.

Although the above-described embodiment is for a case where the dominant eye is the right eye, parallax can be adjusted in similar fashion even if the dominant eye is the left eye.

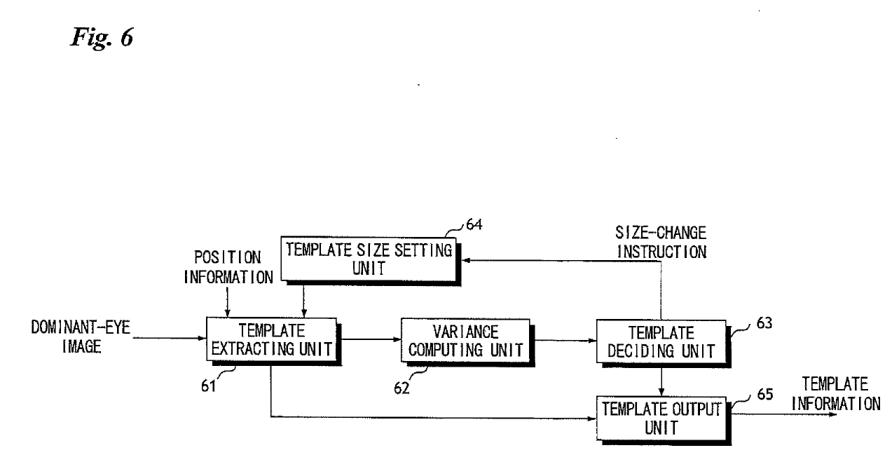

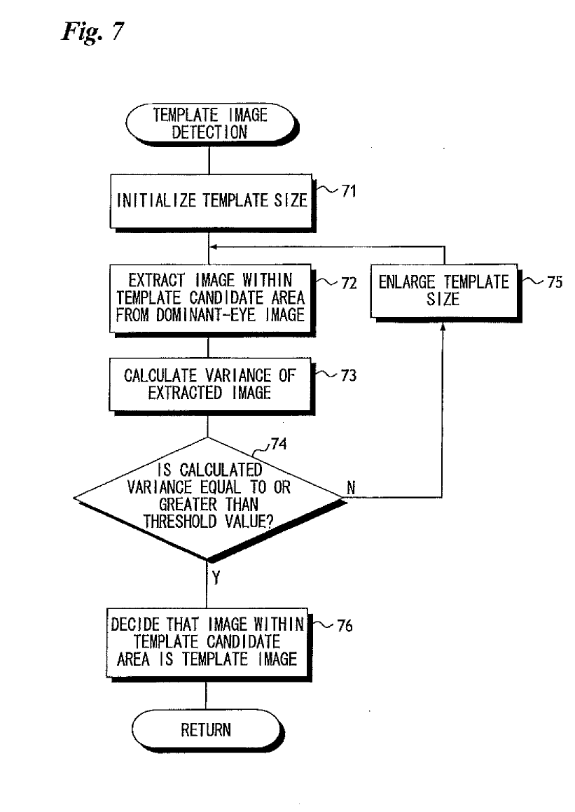

FIGS. 6 and 7 pertain to processing for detecting a template image from a dominant-eye image. In this processing, an image for which the image within the above-mentioned template area has a value equal to or greater than a prescribed threshold value is assumed to be the template image.

FIG. 6 is a block diagram illustrating the electrical configuration of the template setting unit 4.

Image data representing a dominant-eye image and data representing a designated position are input to a template extracting unit 61. A prescribed rectangular area the center of which is the designated position is adopted as a template candidate area. Image data representing the image contained in the template candidate area is input to a variance computing unit 62. Variance VAR of the luminance value of the entered image data is computed in the variance computing unit 62 based upon Equation (2), where p(x,y) is the luminance value of each pixel with the template candidate area, m is the average luminance value of all pixels within the template candidate area, and N is the total number of pixels within the template candidate area.

VAR=Σ(p(x,y)−m)²/(N−1) Equation (2)

The magnitude of variance corresponds to the degree of the texture within the template candidate area. If variance is large, the template candidate area will include much texture. If variance is small, there is a high likelihood that the interior of the template candidate area will be a flat, smooth portion and it is highly likely that erroneous detection will occur in matching processing using the template image. Naturally, besides making use of variance, high-frequency signals of the image within the template candidate area can be extracted utilizing a high-pass filter and a bandpass filter for every pixel within the template candidate area, and use can be made of the quantity of high-frequency signals. Furthermore, it may be arranged so as to detect the amount of edge components within the template candidate area and decide that a template candidate area for which the amount of edge components is equal to or greater than a reference value is the template area.

Data representing the variance computed in the variance computing unit 62 is input to a template deciding unit 63.

If the variance represented by the data that has been input to the template deciding unit 63 is less than a prescribed threshold value, the template deciding unit 63 outputs a command for enlarging the size of the template candidate area and inputs this command to a template size setting unit 64. The template size setting unit 64 controls the template extracting unit 61 in such a manner that the size of the template candidate area is enlarged. The template candidate area whose size has been enlarged is set in the template extracting unit 61, and image data representing the image within the template candidate area is input from the template extracting unit 61 to the variance computing unit 62 as described above. The variance computing unit 62 computes the variance in a manner similar to that set forth above. The above-described processing for enlarging the size of the template candidate area is repeated until the variance exceeds the prescribed threshold value. Naturally, an arrangement may be adopted in which a rectangle one side whereof is, say, 20% of the horizontal width of the image is decided upon as the maximum size and processing for enlarging the size of the template candidate area is repeated to such an extent that the size of the template candidate area will not be exceeded.

If the variance represented by the data that has been input to the template deciding unit 63 is equal to or greater than the prescribed threshold value, then the rectangular area prevailing at this time is decided upon as the template area and the image within the decided template area is decided upon as the template image. Data representing the template image decided is applied to a template output unit 65.

Also applied to the template output unit 65 from the template extracting unit 61 is image data representing the template image extracted from the dominant-eye image. When image data representing the image within the template area decided in the template deciding unit 63 is applied from the template extracting unit 61, this image data is output from the template output unit 65 as the template image data. The template image data is input to the matching unit 5, as described above.

FIG. 7 is a flowchart illustrating the processing procedure for detecting the template image (the processing procedure of step 14 in FIG. 2).

As set forth above, the size of the template candidate area is initialized (step 71). For example, the size of a square the length of one side of which has a length corresponding to 10% of the transverse width of the image serves as the initialized size. The image within the template candidate area is extracted from the dominant-eye image (step 72). The variance of the image extracted from the template candidate area is calculated (step 73). If the calculated variance is not equal to or greater than a prescribed threshold value (“NO” at step 74), the size of the template candidate area is enlarged (step 75), as mentioned above, and the processing of steps 72 to 74 is repeated.

If the calculated variance is equal to or greater than the prescribed threshold value (“YES” at step 74), then the template candidate area is decided upon as the template area and the image within this area is decided upon as the template image (step 76).

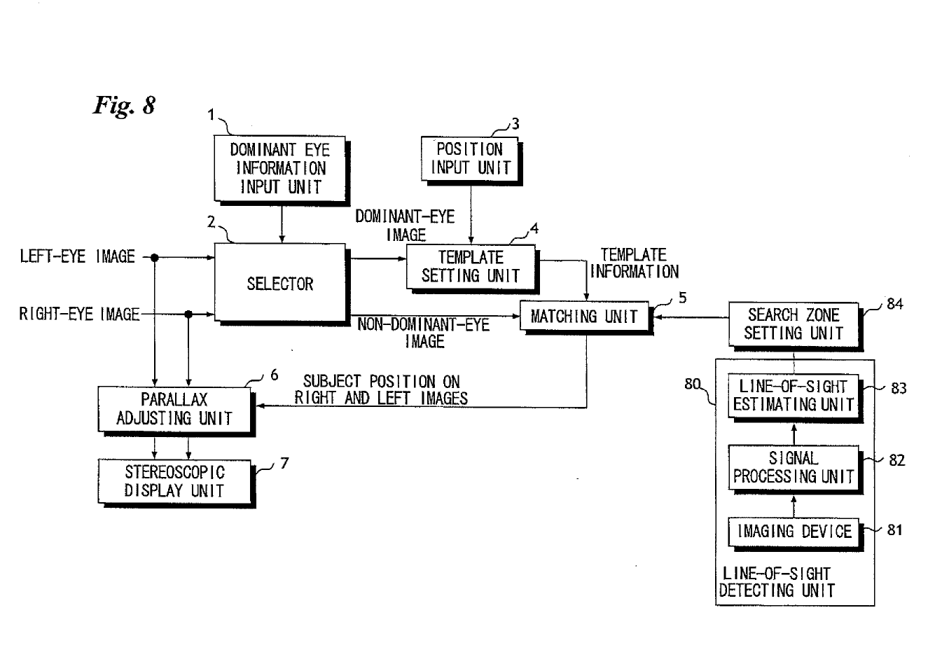

FIGS. 8 to 13 illustrate another embodiment. In this embodiment, the line-of-sight directions of the observer are detected and a search zone for detecting an image identical with the template image in the non-dominant-eye image is decided in accordance with the line-of-sight directions.

FIG. 8 is a block diagram illustrating the electrical configuration of the stereoscopic display system. Components identical with those shown in FIG. 1 are designated by like reference characters and are not described again.

The stereoscopic display system includes a line-of-sight detecting unit 80. The line-of-sight detecting unit 80 includes an imaging device 81. The left eye and right eye of the observer are imaged by the imaging device 81. Image data obtained by imaging the left eye and image data obtained by imaging the right eye are input to a signal processing unit 82. The signal processing unit 82 executes prescribed image processing and inputs the result to a line-of-sight estimating unit 83. The line-of-sight estimating unit 83 detects the iris of the left eye from the left-eye image and the iris of the right eye from the right-eye image. The lines of sight of the observer are detected based upon the detected irises. Data representing the directions of the line of sight are input to a search zone setting unit 84. In regard to a method of detecting the line-of-sight directions, an “Iris Detection Method using LMedS for Line-of-Sight Measurement” (“Image Recognition & Comprehension Symposium (MIRU 2004)”, April 2004), etc., can also be utilized.

A search zone for executing template-image matching processing is decided in the search zone setting unit 84 based upon the line-of-sight directions. Data representing the search zone decided is input from the search zone setting unit 84 to the matching unit 5. Matching processing for detecting an image identical with the template image is detected from within the non-dominant-eye image in the search zone that has been decided.

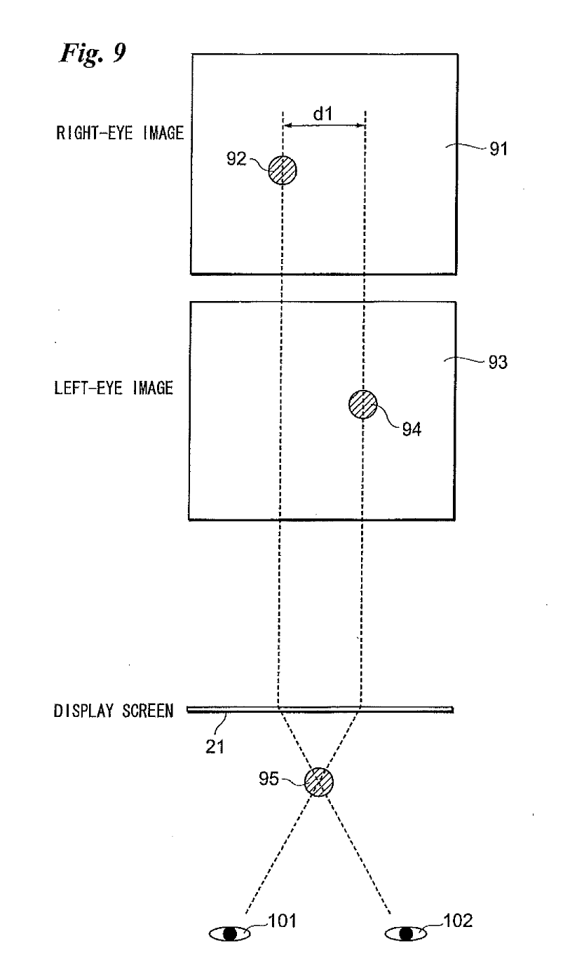

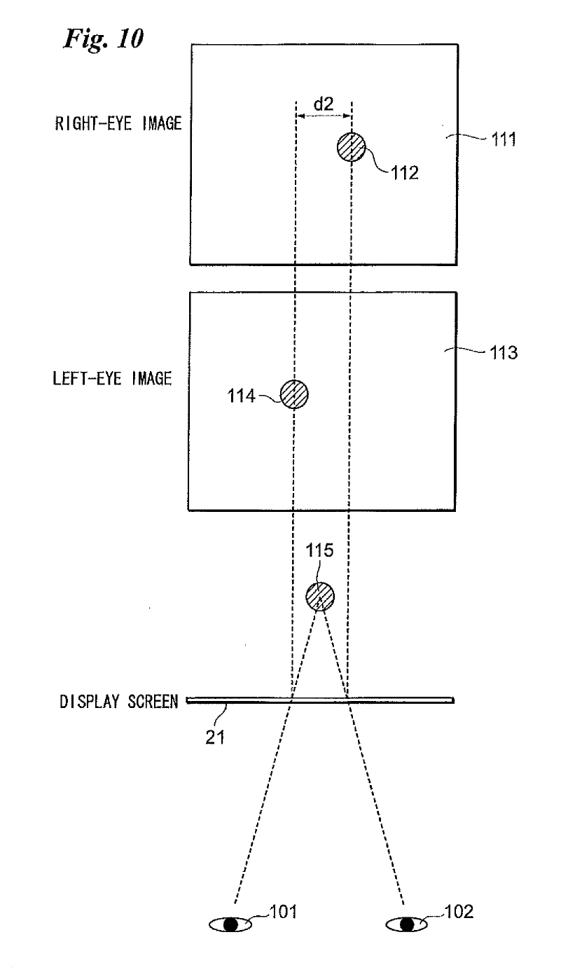

FIGS. 9 and 10 illustrate relationships among lines of sight of an observer, an image portion of a stereoscopic image observed by the observer, and right-eye and left-eye images that constitute the stereoscopic image.

FIG. 9 illustrates a state which prevails when the observer is looking at an image portion 95 seen, in the stereoscopic image, to be forward of the display screen 21 of the stereoscopic image apparatus.

In a case where the image portion (intersection) 95 constituting the stereoscopic image seen to be forward of the display screen 21 is observed by left eye 101 and right eye 102 of the observer, the positional relationship between an image portion 92 of a right-eye image 91 constituting this image portion 95 and an image portion 94 of a left-eye image 93 constituting this image portion 95 is such that the image portion 92 constituting the right-eye image 91 is on the left side of the image portion 94 constituting the left-eye image 93.

FIG. 10 illustrates a state which prevails when the observer is looking at an image portion 115 seen, in the stereoscopic image, to be rearward of the display screen 21 of the stereoscopic image apparatus.

In a case where the image portion (intersection) 115 constituting the stereoscopic image seen to be rearward of the display screen 21 is observed by the left eye 101 and the right eye 102 of the observer, the positional relationship between an image portion 112 of a right-eye image 111 constituting this image portion 115 and an image portion 114 of a left-eye image 113 constituting this image portion 115 is such that the image portion 112 constituting the right-eye image 111 is on the right side of the image portion 114 constituting the left-eye image 113, as opposed to the case where the image is seen to be forward of the display screen 21 of the stereoscopic image apparatus.

If the fact that the image portion 95 is being seen to be forward of the display screen 21 is ascertained by line-of-sight detection, as shown in FIG. 9, then it is considered that, in a case where the dominant eye is the right eye, the image portion 92 in right-eye image 91 is designated when the image portion 95 is designated. The image portion 94 constituting the left-eye image 93 corresponding to this image portion 95 is on the right side of the image portion 92 in the right-eye image 91. Therefore, it will be appreciated that it will suffice if the search zone in the left-eye image 93, which is the non-dominant-eye image, is shifted to the right side of the designated position (parallax d1).

If the fact that the image portion 115 is being seen to be rearward of the display screen 21 is ascertained by line-of-sight detection, as shown in FIG. 10, then it is considered that, in a case where the dominant eye is the right eye, the image portion 112 in right-eye image 111 is designated when the image portion 115 is designated. The image portion 114 constituting the left-eye image 113 corresponding to this image portion 115 is on the left side of the image portion 112 in the right-eye image 111. Therefore, it will be appreciated that it will suffice if the search zone in the left-eye image 113, which is the non-dominant-eye image, is shifted to the left side of the designated position (parallax d2).

In the above-described example, it is assumed that the dominant eye is the right eye. However, it will be appreciated that the search zone can be similarly limited based upon the light-of-sight directions [namely whether the image portion (intersection) in the stereoscopic image being observed by the observer is forward or rearward of the display screen 21] even if the dominant eye is the left eye.

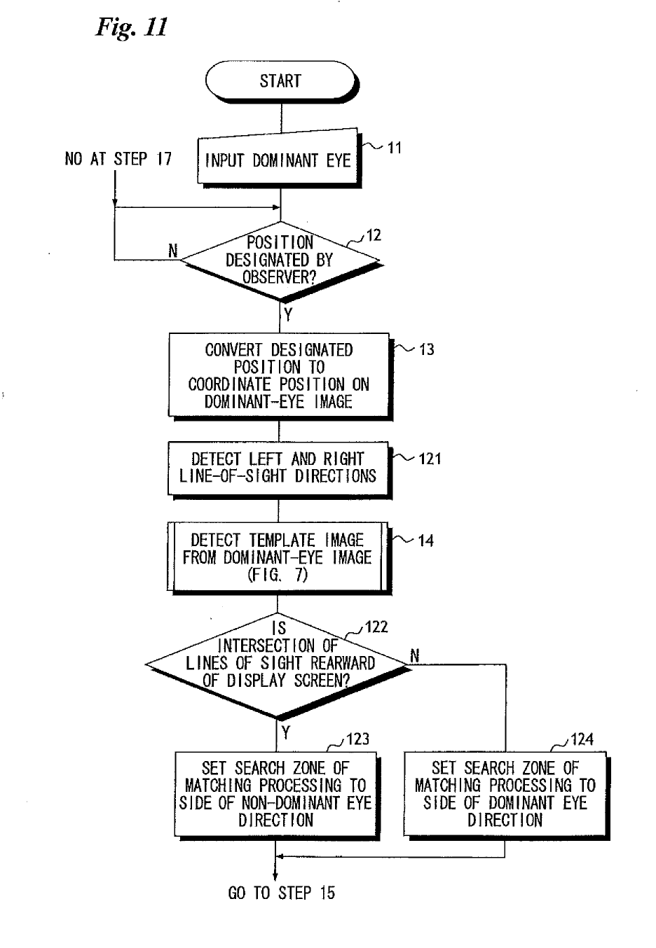

FIG. 11 is a flowchart illustrating the processing procedure of the stereoscopic display system. In FIG. 11, processing steps identical with those shown in FIG. 2 are designated by like step numbers and are not described again.

The line-of-sight directions of the observer are detected (step 121) in the manner described above. Whether the intersection of the lines of sight is forward or rearward of the display screen is checked based upon the lines of sight detected (step 122). As described above, if the image portion being observed by the observer is forward of the display screen, then the intersection of the lines of sight is forward of the display screen, and if the image portion being observed by the observer is rearward of the display screen, then the intersection of the lines of sight is rearward of the display screen.

If the intersection of the lines of sight is forward the display screen (“YES” at step 122), then the search zone of matching processing for detecting the image identical with the template image is set on the side of the non-dominant eye direction (step 123). For example, if the dominant eye is the right eye, then the direction of the non-dominant eye is on the left side, and if the dominant eye is the left eye, then the direction of the non-dominant eye is on the right side. If the intersection of the lines of sight is rearward of the display screen (“NO” at step 122), then the search zone of matching processing is set on the side of the dominant eye direction (step 124).

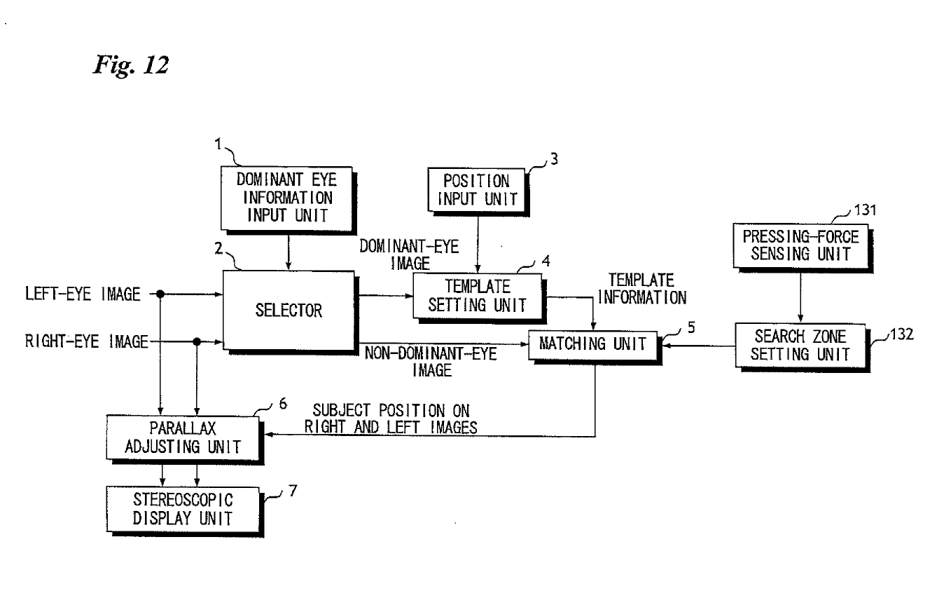

FIGS. 12 to 14 illustrates another embodiment.

FIG. 12 is a block diagram illustrating the electrical configuration of a stereoscopic image display apparatus. Components identical with those shown in FIG. 1 are designated by like reference characters and are not described again.

In this embodiment, a touch panel (not shown) has been formed on the stereoscopic display screen. The stereoscopic display system has been provided with a pressing-force sensing unit 131 in order to detect pressure when the touch panel is pressed to designate a position.

If the touch panel is pressed to designate a position on the panel, it is considered that the pressing force will be less than a reference value when an effort is made to press the image portion 95 that appears in front of the display screen 21 as shown in FIG. 9. The pressure at the time of such pressing, therefore, is small. On the other hand, it is considered that the pressing force will be greater than the reference value when an effort is made to press the image portion that appears in back of the display screen 21 as shown in FIG. 10. The pressure at the time of such pressing, therefore, is large. The reference value is a pressing force that prevails when the observer touches the panel in a case where an image portion of a stereoscopic image devoid of parallax is displayed on the display screen. Thus, the pressing force that prevails when an image portion devoid of parallax is displayed and this image portion is touched is the reference value. Preferably, the pressing force that prevails when the observer touches the panel in an instance where a stereoscopic image portion devoid of parallax is displayed on the display screen is detected multiple times and the average value, mode or median value thereof is adopted as the reference value.

It is considered that in a case where the pressure sensed by the pressing-force sensing unit 131 is equal to or greater than the prescribed reference value, the image portion that the observer is attempting to press will be in back of the display screen 21. As a consequence, a search zone setting unit 132 sets the search zone for matching processing on the side of the non-dominant eye direction, as mentioned above. It is considered that in a case where the pressure sensed by the pressing-force sensing unit 131 is less than the prescribed reference value, the image portion that the observer is attempting to press will be in front of the display screen 21. As a consequence, the search zone setting unit 132 sets the search zone for matching processing on the side of the dominant eye direction, as mentioned above.

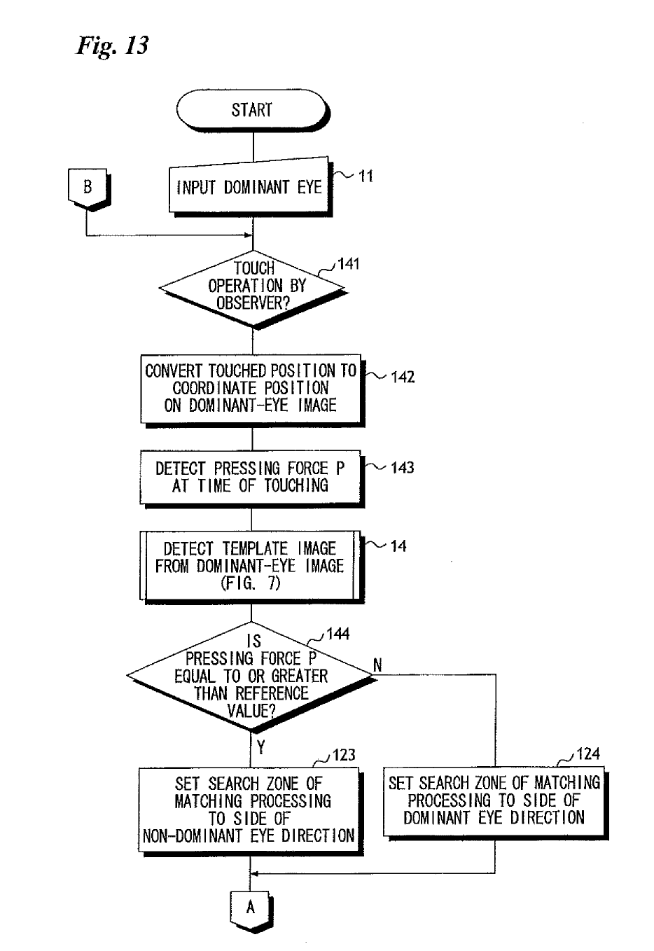

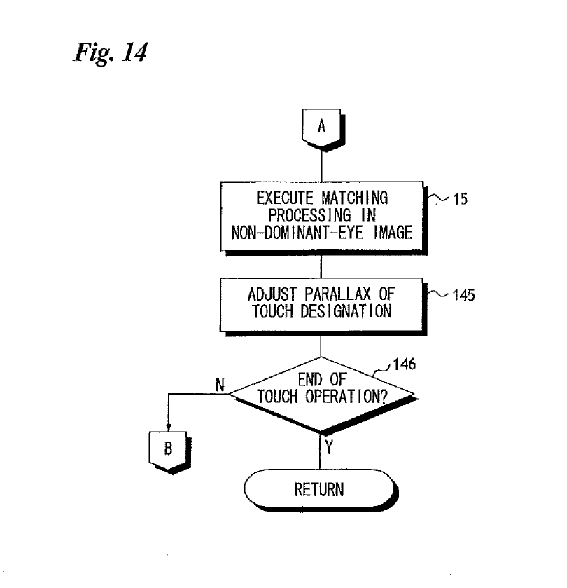

FIGS. 13 and 14 are flowcharts illustrating the processing procedure of the stereoscopic display system. In FIGS. 13 and 14, processing steps identical with those shown in FIG. 2 are designated by like step numbers and are not described again.

If the observer performs a touch operation (“YES” at step 141), the positional coordinates of respective ones of the left-eye image and right-eye image at the touched position are calculated (step 142). A pressing force P obtained at the time of touching is detected (step 143).

If the pressing force P is equal to or greater than a reference value (“YES” at step 144), the search zone for matching processing is set on the side of the non-dominant eye direction (step 123). If the pressing force is less than the reference value (“NO” at step 144), then the search zone for matching processing is set on the side of the dominant eye direction (step 124). The non-dominant-eye image is subjected to matching processing (step 15) and the parallax of the touched position is adjusted (step 145). The processing from step 141 onward is repeated until the touch-operation processing ends (step 146).

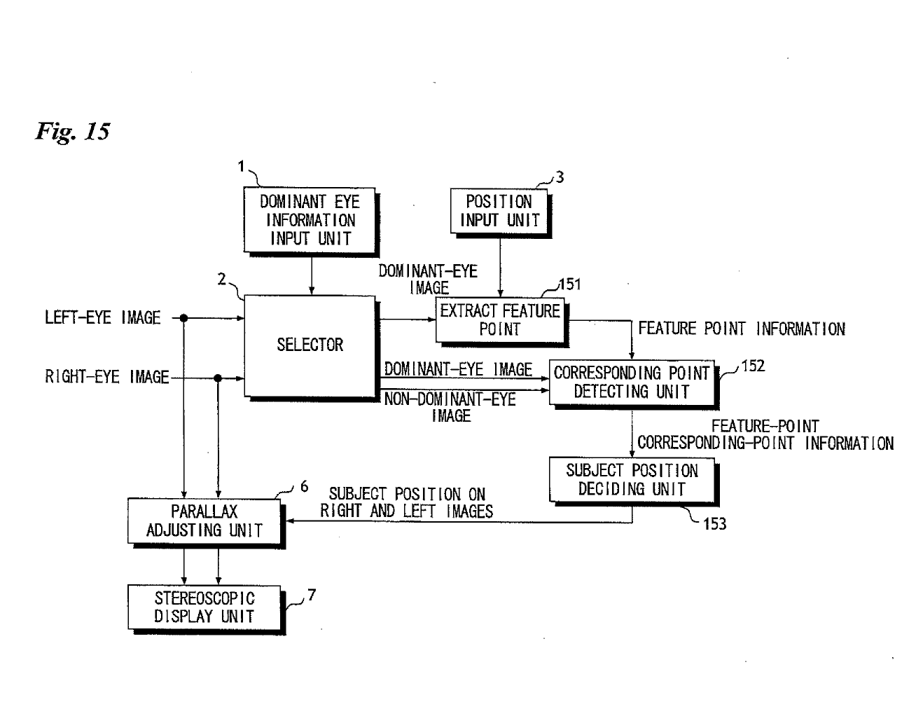

FIGS. 15 to 18 illustrate another embodiment.

In the foregoing embodiments, a template image is detected from a dominant-eye image and matching processing for detecting an image identical with the detected template image from a non-dominant-eye image is executed. In this embodiment, however, a feature point is detected from the dominant-eye image and a corresponding feature point, which is a point that corresponds to the feature point, is detected from the non-dominant-eye image. A parallax adjustment is carried out based upon a distance differential between the feature point and corresponding feature point that have been detected. A feature point is a point (pixel) having strong signal gradients in a plurality of directions and can be extracted using the Harris method or the Shi-Tomasi method, by way of example. A method of detecting a corresponding feature point (Xi,Yi) corresponding to a feature point (xi,yi) is, for example, the Lucas-Kanade method. Parallax d at the feature point can be calculated according to d=Xi−xi. In a case where there are multiple feature points, a subject position xt2 on the left-eye image, which corresponds to an image portion present at a designated position xt1 on the right-eye image, is calculated according to Equation (3) below.

xt2=Σdi/N+xt1 Equation (3)

where N is the number of feature points and Σdi is the sum total of parallaxes possessed by the respective feature points. Although the parallaxes of multiple feature points are averaged in Equation (3), it is permissible to adopt the median value or to use the parallax of a feature point that is nearest to the designated position.

FIG. 15 is a block diagram illustrating the electrical configuration of a stereoscopic display system. Components identical with those shown in FIG. 2 are designated by like reference characters and are not described again.

Image data representing the dominant-eye image and data representing the designated position that is output from the position input unit 3 is input to a feature point extracting unit 151.

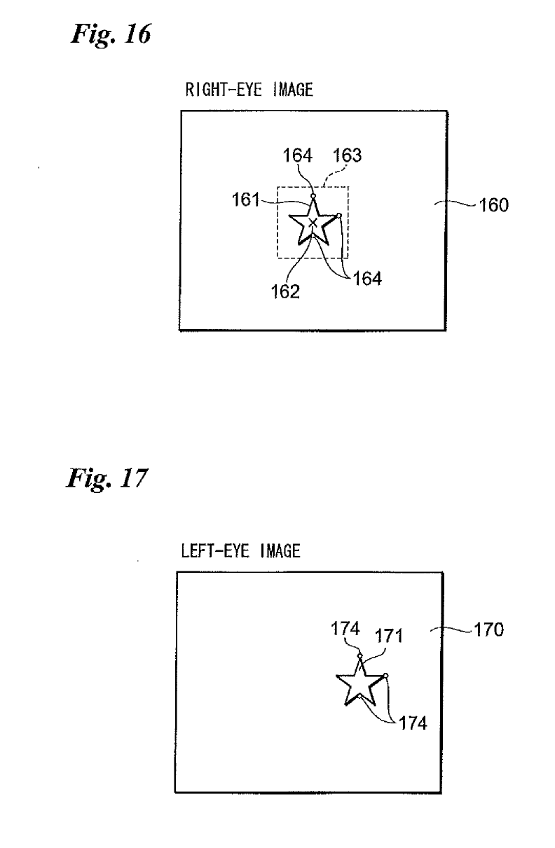

FIG. 16 is an example of a right-eye image (it is assumed that the right-eye image is the dominant-eye image).

Assume that a position corresponding to the designated position is a position 162 in a right-eye image 160. It is assumed that a prescribed range from this position 162 is a feature point extraction area 163. Feature points 164 of an image 161 that exist within the feature point extraction area 163 are detected.

As shown in FIG. 16, information concerning the feature points detected from the dominant-eye image is applied to a corresponding point detecting unit 152 from the feature point extracting unit 151. In addition to the feature point information, the dominant-eye image data and the non-dominant-eye image data is applied to the corresponding point detecting unit 152 from the selector 2. The corresponding point detecting unit 152 detects corresponding feature points based upon the dominant-eye image data and non-dominant-eye image data.

FIG. 17 is an example of a left-eye image.

Corresponding feature points 174 around an image 171 corresponding to the image 161 that contains the designated position 162 in the right-eye image 160 are detected in a left-eye image 170 in the manner described above.

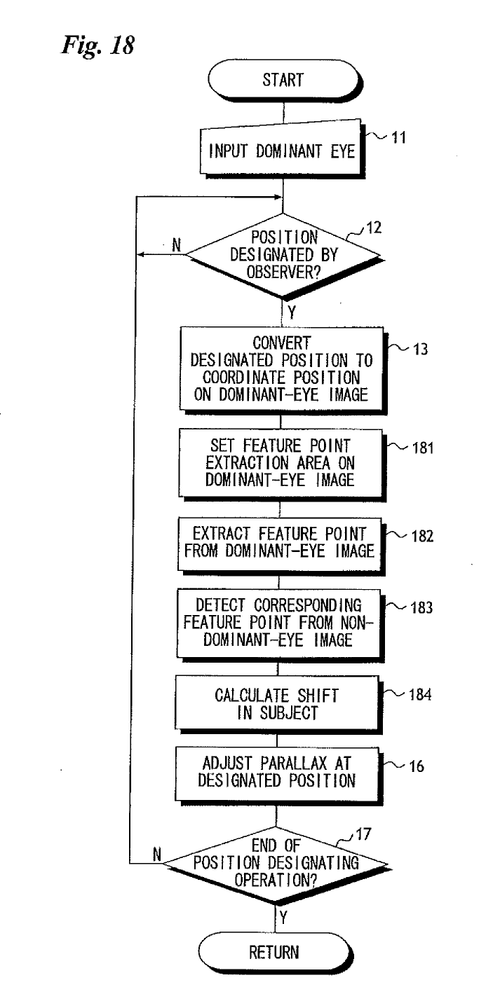

FIG. 18 is a flowchart illustrating the processing procedure of the stereoscopic display system. In FIG. 18, processing steps identical with those shown in FIG. 2 are designated by like step numbers and are not described again.

A feature point extraction area is set on the dominant-eye image (step 181) in the manner described above. A feature point is extracted from the image within the set feature point extraction area (step 182). A corresponding feature point is detected from the non-dominant-eye image (step 183). A shift of the subject is detected from the offset between the detected feature point and corresponding feature point (step 184). A parallax adjustment is carried out based upon the detected shift (step 16).

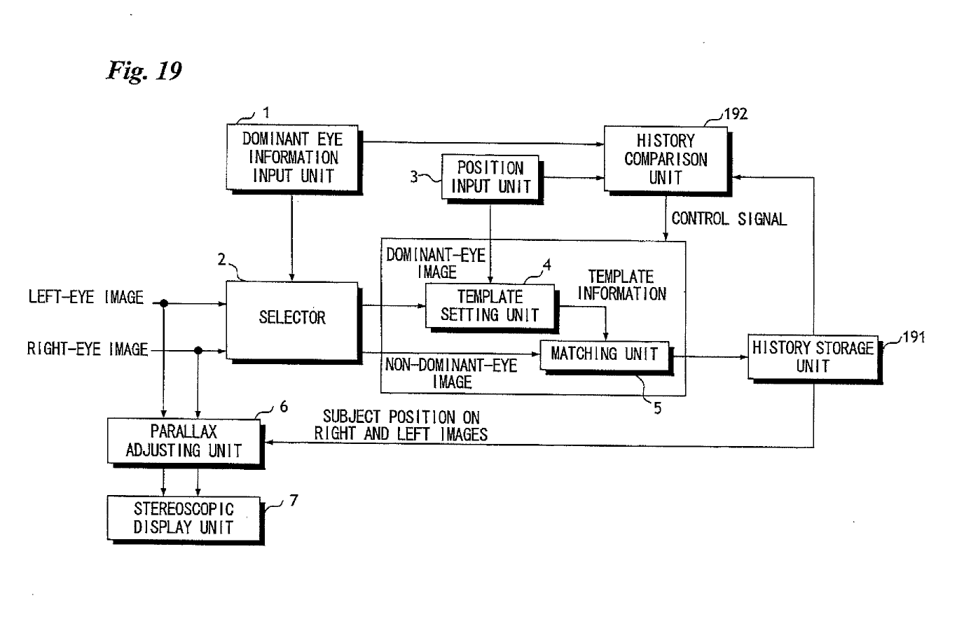

FIGS. 19 to 22 illustrate yet another embodiment. Corresponding relationships between designated positions in a right-eye image and corresponding positions in a left-eye image corresponding to these designated positions (or between designated positions in the left-eye image and corresponding positions in the right-eye image corresponding to these designated positions) are stored beforehand in a history table. If a corresponding relationship in the vicinity of a designated position has been stored in the history table, then this stored corresponding relationship is utilized.

FIG. 19 is a block diagram illustrating the electrical configuration of a stereoscopic image display apparatus. Components identical with those shown in FIG. 1 are designated by like reference characters and are not described again.

Information concerning respective ones of an entered designated position and a detected corresponding position are output from the matching unit 5 and input to a history storage unit 191. The information that has been stored in the history storage unit 191 is input to a history comparison unit 192. Designated position information that is output from the position input unit 3 also is input to the history comparison unit 192. In a case where a position close to a corresponding relationship of a designated position already stored in the history storage unit 191 has been designated, position information that has been stored in the history storage unit 191 is utilized in the history comparison unit 192 without processing for detecting a template image being executed.

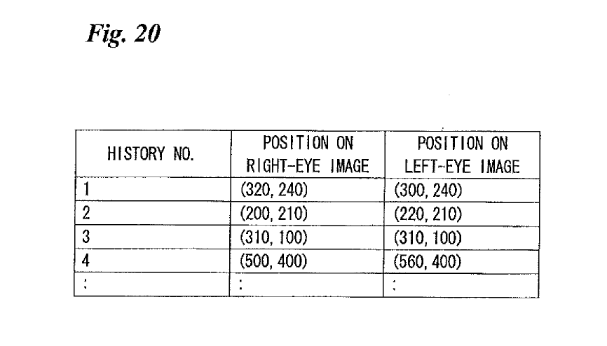

FIG. 20 is an example of the history table.

A position on the right-eye image and a position on the left-eye image corresponding to the position on the right-eye image have been stored for every history number. If the right-eye image is designated, then the designated position on the right-eye image is stored as a position on the right-eye image and the corresponding position on the left-eye image corresponding to the designated position on the right-eye image is stored as a position on the left-eye image. Conversely, if the left-eye image is designated, then the designated position on the left-eye image is stored as a position on the left-eye image and the corresponding position on the right-eye image corresponding to the designated position on the left-eye image is stored as a position on the right-eye image. Such a history table is generated for every image and stored.

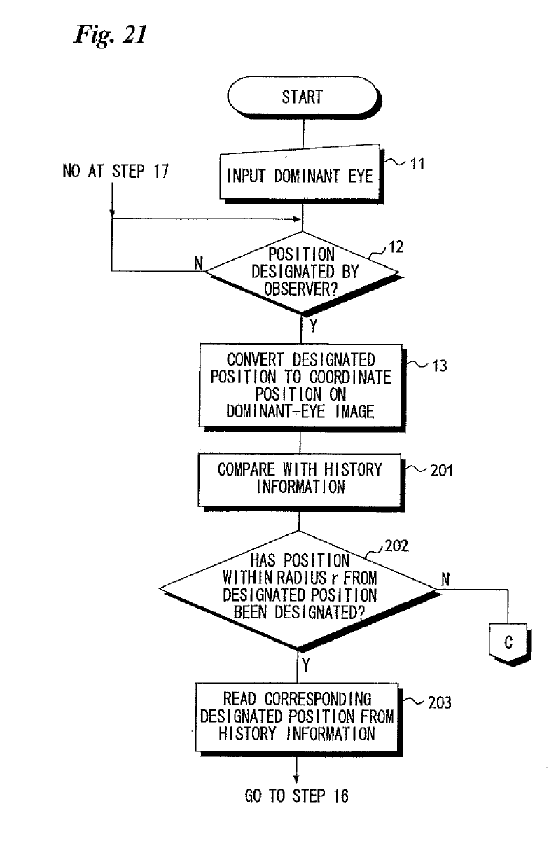

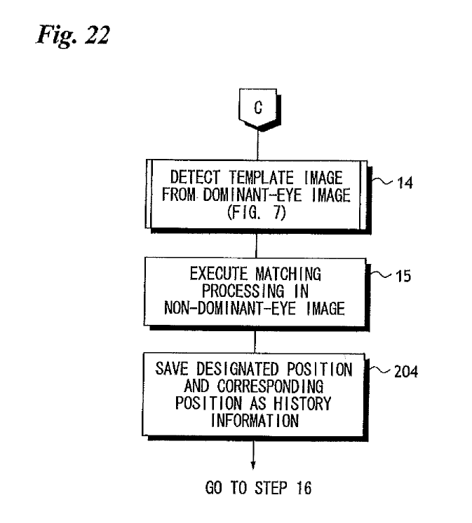

FIGS. 21 and 22 are flowcharts illustrating the processing procedure of the stereoscopic display system. In FIGS. 21 and 22, processing steps identical with those shown in FIG. 2 are designated by like step numbers and are not described again.

When the coordinate position of an entered designated position is detected, it is determined whether a designated position has been stored in the history table within a prescribed radius r from a designated position, the latter being a designated position on the dominant-eye image (step 202).

If such a designated position has been stored (“YES” at step 202), then the corresponding position is read from the history information table (step 203). Further, a position that has been stored within the prescribed radius r from the designated position is read as well. The position on the right-eye image and the position on the left-eye image are thus read from the history information table. For example, if the coordinates of a position designated on the right-eye image are (300,110), then it is determined whether a position on the right-eye image has been stored within the radius r (e.g., 20 pixels) from this designated position. For example, since a position (310,100) on the right-eye image designated by History No. 3 exists, coordinates (310,100) (a position on the right-eye image) designated by History No. 3 and coordinates (310,100) (a position on the left-eye image) are read. A parallax adjustment is carried out utilizing the read coordinates (step 16).

If a designated position has not been stored in the history table within the prescribed radius r from the designated position (“NO” at step 202), then the template image is detected and processing for performing matching with the detected template image is executed (steps 14, 15). The corresponding relationship between the coordinates of respective ones of the detected designated position and corresponding position are stored in the history table as history information (step 204).

1. A stereoscopic image display apparatus for allowing a user to view a stereoscopic image by displaying on a display screen a left-eye image observed by the left eye of the user and a right-eye image observed by the right eye of the user, comprising:
a dominant-eye setting device for setting a dominant eye of the user;
a position designating device for designating a position on the display screen at which a portion whose parallax is to be adjusted is being displayed;
a template image detecting device for detecting, as a template image in whichever of the left-eye image or right-eye image is an image observed by the dominant eye set by the dominant-eye setting device, an image portion that exists at a position corresponding to the position on the display screen designated by said image designating device; and
a template matching device for detecting the position of a matching image, which is an image identical with the template image detected by said template image detecting device, in whichever of the left-eye image or right-eye image is an image observed by an eye different from the dominant eye set by said dominant-eye setting device.

2. A stereoscopic image display apparatus according to claim 1, wherein said template image detecting device includes:
an edge component amount determination device for determining, in whichever of the left-eye image or right-eye image is an image observed by the dominant eye set by said dominant-eye setting device, whether an amount of edge components of an image within a template-image candidate area of a prescribed size centered on the position corresponding to the position on the display screen designated by said position designating device is equal to or greater than a prescribed threshold value;
an enlarging device for enlarging the size of the template-image candidate area in accordance with a determination by said edge component amount determination device that the amount of edge component amounts is not equal to or greater than the prescribed threshold value;
a control device for controlling said edge component amount determination device so as to determine whether the amount of edge components of the image within the template image candidate area enlarged by said enlarging device is equal to or greater than the prescribed threshold value; and
a template image deciding device for deciding, in accordance with a determination by said edge component amount determination device that the amount of edge components is equal to or greater than the prescribed threshold value, that the image within the template-image candidate area is a template image.

3. A stereoscopic image display apparatus according to claim 2, further comprising an intersection position detecting device for detecting whether an intersection between a left-eye line of sight and a right-eye line of sight of the user is forward or rearward of the display screen;
wherein said template matching device, in accordance with a determination by said intersection position detecting device that the intersection is forward of the display screen, detects the matching image from the image observed by the different eye in a direction on the dominant-eye side of the position corresponding to the position on the display screen designated by said position designating device, and in accordance with a determination by said intersection position detecting device that the intersection is rearward of the display screen, detects the position of the matching image from the image observed by the different eye in a direction on the non-dominant-eye side of the position corresponding to the position on the display screen designated by said position designating device.

4. A stereoscopic image display apparatus according to claim 3, wherein a touch panel has been formed on the display screen;
said position designating device includes a pressure determination device for determining whether pressure at a position touched on the touch panel is equal to or greater than a prescribed reference value; and
said template matching device, in accordance with a determination by said pressure determination device that the pressure is equal to or greater than the prescribed reference value, detects the matching image from the image observed by the different eye in a direction on the dominant-eye side of the position corresponding to the position on the display screen designated by said position designating device, and in accordance with a determination by said pressure determination device that the pressure is less than the prescribed reference value, detects the position of the matching image from the image observed by the different eye in a direction on the non-dominant-eye side of the position corresponding to the position on the display screen designated by said position designating device.

5. A stereoscopic image display apparatus according to claim 4, wherein said template image detecting device detects a feature point, which is in the vicinity of the image portion that exists at the position corresponding to the position on the display screen designated by said position designating device, in whichever of the left-eye image or right-eye image is an image observed by the dominant eye set by said dominant-eye setting device; and
said template matching device detects a feature point, which corresponds to the feature point detected by said template image detecting device, in whichever of the left-eye image or right-eye image is an image observed by the eye different from the dominant eye set by said dominant-eye setting device.

6. A stereoscopic image display apparatus for allowing a user to view a stereoscopic image by displaying on a display screen a left-eye image observed by the left eye of the user and a right-eye image observed by the right eye of the user, comprising:
a dominant-eye setting device for setting a dominant eye of the user;
a position designating device for designating a position on the display screen at which a portion whose parallax is to be adjusted is being displayed;
a designated-position-coordinate detecting device for detecting designated-position coordinates, which correspond to the position on the display screen designated by said image designating device, in whichever of the left-eye image or right-eye image is an image observed by the dominant eye set by said dominant-eye setting device;
a corresponding-position-coordinate existence/non-existence determination device for determining whether items of data, which represent both a position within a prescribed range from the designated-position coordinates detected by said designated-position-coordinate detecting device and a position corresponding to the position within the prescribed range in whichever of the left-eye image or right-eye image is an image observed by an eye different from the dominant eye set by said dominant-eye setting device, have been stored in a memory;
a readout device for reading the items of data representing both of the positions out of the memory in response to a determination by said corresponding-position-coordinate existence/non-existence determination device that the items of data representing both of the positions have been stored in the memory;
a template image detecting device, responsive to a determination by said corresponding-position-coordinate existence/non-existence determination device that at least one item of the items of data representing both of the positions has not been stored in the memory, for detecting, as a template in whichever of the left-eye image or right-eye image is an image observed by the dominant eye set by said dominant-eye setting device, an image portion that exists at a position corresponding to the position on the display screen designated by said image designating device;
a template matching device for detecting the position of a matching image, which is an image identical with the template image detected by said template image detecting device, in whichever of the left-eye image or right-eye image is an image observed by the eye different from the dominant eye set by said dominant-eye setting device; and
a memory control device for storing, in the memory, data representing the position of the template image detected by said template image detecting device and contained in the image observed by the dominant eye and data representing the position of the matching image detected by said template matching device and contained in the image observed by the eye different from the dominant eye.

7. A method of controlling a stereoscopic image display apparatus for allowing a user to view a stereoscopic image by displaying on a display screen a left-eye image observed by the left eye of the user and a right-eye image observed by the right eye of the user, comprising:
setting a dominant eye of the user; designating a position on the display screen at which a portion whose parallax is to be adjusted is being displayed;
detecting, as a template image in whichever of the left-eye image or right-eye image is an image observed by the set dominant eye, an image portion that exists at a position corresponding to the designated position on the display screen; and
detecting the position of a matching image, which is an image identical with the detected template image, in whichever of the left-eye image or right-eye image is an image observed by an eye different from the set dominant eye.

8. A method of controlling a stereoscopic image display apparatus for allowing a user to view a stereoscopic image by displaying on a display screen a left-eye image observed by the left eye of the user and a right-eye image observed by the right eye of the user, comprising:
setting a dominant eye of the user;
designating a position on the display screen at which a portion whose parallax is to be adjusted is being displayed;
detecting designated-position coordinates, which correspond to the designated position on the display screen, in whichever of the left-eye image or right-eye image is an image observed by the set dominant eye;
determining whether items of data, which represent both a position within a prescribed range from the detected designated-position coordinates and a position corresponding to the position within the prescribed range in whichever of the left-eye image or right-eye image is an image observed by an eye different from the set dominant eye, have been stored in a memory;
reading the items of data representing both of the positions out of the memory in response to a determination that the items of data representing both of the positions have been stored in the memory;
in response to a determination that at least one item of the items of data representing both of the positions has not been stored in the memory, detecting, as a template in whichever of the left-eye image or right-eye image is an image observed by the set dominant eye, an image portion that exists at a position corresponding to the designated position on the display screen;
detecting the position of a matching image, which is an image identical with the template image detected by template image detecting device, in whichever of the left-eye image or right-eye image is an image observed by the eye different from the set dominant eye; and
storing, in the memory, data representing the position of the template image detected and contained in the image observed by the dominant eye and data representing the position of the matching image detected and contained in the image observed by the eye different from the dominant eye.
